(19) United States
(12) Patent Application Publication
(10) Pub. No.: US 2017/0109712 A1
(43) Pub. Date: Apr. 20, 2017

(54) SYSTEM AND METHOD FOR GENERATING MAINTENANCE SCHEDULE

(71) Applicant: Caterpillar Inc., Peoria, IL (US)

(72) Inventor: Robert G. Bullock, Germantown Hills, IL (US)

(73) Assignee: CATERPILLAR INC., Peoria, IL (US)

(21) Appl. No.: 14/882,499

(22) Filed: Oct. 14, 2015

(51) Int. Cl. G06Q 10/00; H04W 4/14; H04L 29/08; G06Q 10/10

(52) U.S. Cl. CPC G06Q 10/20; G06Q 10/1097; H04W 4/14; H04L 67/26

(57) ABSTRACT

A method for generating a maintenance schedule for a machine is provided. The method includes receiving an identification code of the machine to be maintained. The method includes identifying the machine based on the identification code. The method includes obtaining at least one machine parameter associated with the maintenance of the machine. The method includes receiving a first input indicative of selecting a component in the machine. The method also includes receiving a second input indicative of a notification frequency for the selected component. The method also sending a notification based on the notification frequency. The method also includes receiving a third input, in response to the notification. The third input is indicative of an operational parameter of the component. The method further includes generating the maintenance schedule of the component based on the received operational parameter of the component and the predetermined maintenance schedule.

### TECHNICAL FIELD

The present disclosure is related to a system and method for generating a maintenance schedule associated with a machine, and more particularly to a system and method for updating a maintenance schedule associated with the machine.

### BACKGROUND

Machines such as, dump trucks, excavators, etc., communicate with a maintenance management system over a communication network. The maintenance system monitors one or more components of the machine, such as an engine system to generate a maintenance schedule of the machine. The maintenance management systems include a maintenance tool that gathers data associated with operation of the machine. The maintenance management system also includes a computing device to determine the maintenance schedule based on the data received by the maintenance tool. Further, the maintenance management system includes a user interface which displays the maintenance schedule of the one or more components of the machine.

U.S. Pat. No. 8,155,817 discloses a vehicle maintenance reporting system and method that utilizes a vehicle email notification system in which triggers are used to initiate the generation and transmission of email messages that provide diverse types of dynamic vehicle information to the owner or other authorized subscriber. The email notifications are triggered by different events, some of which are independent of the vehicle (e.g., a monthly trigger), and others of which occur at the vehicle, such as a mileage or low oil life trigger. The notification system builds and sends to the subscriber an email message that contains the dynamic vehicle information. Maintenance service events such as an oil change reset are detected and used to trigger email reporting to the subscriber as well to transmit the oil change reset event back to a central data system where it is included in a vehicle maintenance record.

### SUMMARY OF THE DISCLOSURE

One aspect of the present disclosure relates to a method of updating a maintenance schedule for a machine. The method includes receiving a first input indicative of selecting a component in the machine. The method also includes receiving a second input indicative of a notification frequency for the selected component. The method also includes sending a notification based on the notification frequency. The method also includes receiving a third input, in response to the notification, the third input is indicative of an operational parameter of the component. The method further includes updating the maintenance schedule of the component based on the received operational parameter of the component.

Another aspect of the present disclosure relates to a maintenance system for a machine. The maintenance system includes a maintenance schedule interface configured to receive a first input and a second input. The first input is indicative of selecting a component in the machine and the second input is indicative of a notification frequency for the selected component. The maintenance system further includes a processor in communication with the maintenance schedule interface. The processor includes an output module configured to send a notification, based on the notification frequency, to a user device. The processor also includes an output module configured to send a notification, based on the notification frequency, to a user device. The processor also includes an input module configured to receive a third input indicative of an operational parameter of the component. The processor further includes a processing module configured to update the maintenance schedule of the component based on the received operational parameter of the component.

Another aspect of the present disclosure relates to a method for generating a maintenance schedule for a machine. The method includes receiving an identification code of the machine to be maintained, the identification code being indicative of unique information specific to the machine. The method includes identifying the machine based on the identification code. The method includes obtaining at least one machine parameter associated with the maintenance of the machine. The method includes receiving a first input indicative of selecting a component in the machine. The method also includes receiving a second input indicative of a notification frequency for the selected component. The method also sending a notification based on the notification frequency. The method also includes receiving a third input, in response to the notification. The third input is indicative of an operational parameter of the component. The method further includes generating the maintenance schedule of the component based on the received operational parameter of the component and the predetermined maintenance schedule.

Other features and aspects of this disclosure will be apparent from the following description and the accompanying drawings.

### BRIEF DESCRIPTION OF THE DRAWINGS

FIG. 1 is a system for generating a maintenance schedule of a machine, according to an embodiment of the present disclosure;

FIG. 2 is a maintenance schedule interface of the system displaying a process tab for selecting a machine, according to an embodiment of the present disclosure;

FIG. 3 is a maintenance schedule interface of the system displaying a process tab for selecting a component of the machine, according to an embodiment of the present disclosure;

FIG. 4 is a maintenance schedule interface of the system displaying a process tab for selecting a frequency of notifications, according to an embodiment of the present disclosure;

FIG. 5 illustrates an exemplary user device displaying a notification, according to an embodiment of the present disclosure;

FIG. 6 illustrates the user device of FIG. 6 for providing an operational parameter associated with the machine, according to an embodiment of the present disclosure;

FIG. 7 is a maintenance schedule interface of the system displaying an exemplary output, according to an embodiment of the present disclosure;

FIG. 8 is a flowchart of a method for updating a maintenance schedule for the machine, according to an embodiment of the present disclosure; and

FIG. 9 is a flowchart of a method for generating a maintenance schedule for the machine, according to an embodiment of the present disclosure.

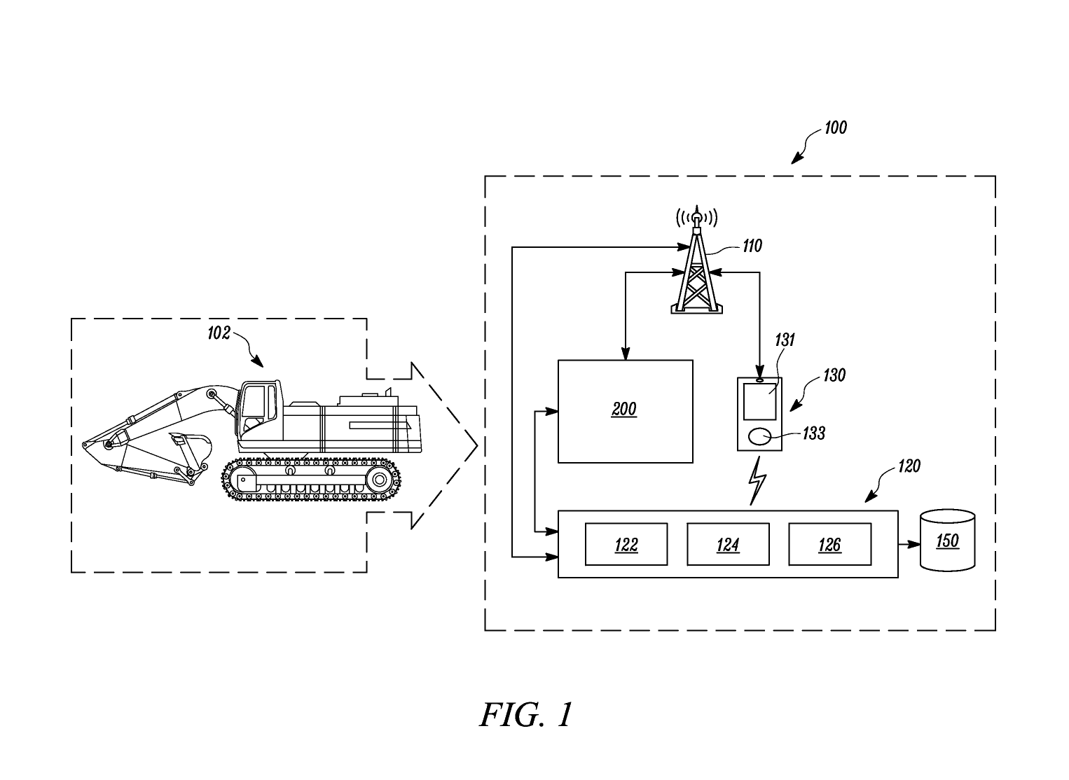

### DETAILED DESCRIPTION

Wherever possible, the same reference numbers will be used throughout the drawings to refer to same or like parts. FIG. 1 illustrates a maintenance system 100 associated with a machine 102, according to an embodiment of the present disclosure. The maintenance system 100 may be used to generate and update a maintenance schedule of the machine 102. The maintenance system 100 is also configured to notify a user of the machine 102 to perform a repair operation based on the maintenance schedule. The machine 102 may be deployed on a worksite, a mine site, a construction site and the like, for performing one or more operations such as, transportation of material from one location to another. The machine 102 may be for example, a hydraulic excavator, a loader, a mining truck, a haul truck, an on-highway truck, an off-highway truck, an articulated truck, and the like. The machine 102 deployed on the worksite may include manned machines, autonomous machines or semi-autonomous machine. In an embodiment, the machine 102 may be in communication with a number of telematics data providers (not shown) for monitoring and/or controlling one or more functions of the machine. Otherwise, the maintenance system 100 may be used to update and generate the maintenance schedule for one or more components of the machine 102 that are not being monitored with the telematics data providers.

Referring to FIG. 1, the maintenance system 100 includes a processor 120, a database 150, a maintenance schedule interface 200 and a user device 130. In an embodiment, the maintenance system 100 may be implemented as a web-based application. For example, the maintenance system 100 may be a cloud implemented platform hosted in one or more servers accessible to a user over a communication network e.g., internet.

The processor 120 of the maintenance system 100 is configured to generate the maintenance schedule of the machine 102 based on inputs received from the user device 130, and the maintenance schedule interface 200. The processor 120 communicates with the user device 130, and the maintenance schedule interface 200, via a network 110. The network 110 may be, for example, a wide area network (WAN), a local area network (LAN), an ethernet, an internet, an intranet, a cellular network, a satellite network, or any other suitable network for transmitting data between the user and the maintenance system 100. In various embodiments, the network 110 may include a combination of two or more of the aforementioned networks and/or other types of networks known in the art. The network 110 may be implemented as a wired network, a wireless network or a combination thereof. Further, data transmission may take place over the network 110 with a network protocol such that the data transmission is in an encrypted format, any other secure format, or in any of a wide variety of known manners.

The processor 120 receives inputs associated with generating the maintenance schedule via the network 110 and generates the maintenance schedule based on the received inputs. The processor 120 includes an input module 122, a processing module 124 in communication with the input module 122, and an output module 126 in communication with the processing module 124. The input module 122 may be configured to receive one or more inputs from the user device 130 and the maintenance schedule interface 200. The input module 122 may further process the received inputs to generate one or more input signals that can be processed by the processing module 124. Based on the input signals, the processing module 124 executes instructions and/or programs to either generate or update the maintenance schedule in the maintenance schedule interface 200. The output module 126 is configured to send output signals to the maintenance schedule interface 200 for displaying the generated or updated maintenance schedule.

The processor 120 is also in communication with the database 150. The database 150 is configured to store a set of data associated with the machine 102. The set of data may include at least one of predetermined maintenance schedule, a performed maintenance schedule, an operating schedule, one or more job site data, machine parameters, user information or any other information. The machine parameters may include, for example, utility of a machine, a machine specification, a type of machine, an engine serial number and running life of one or more components of the machine 102, etc. Moreover, information associated with component manufacturing, utility, etc., may also be stored in the database 150. In an embodiment, the database 150 may also store optimum working conditions for the components and the machine 102. More specifically, the processing module 124 may lookup in the database 150 and retrieves information associated with machine 102 to update the maintenance schedule. The database 150 may also be configured to store output files received from the processor 120. In one embodiment, the database 150 may be an in-built memory that is integral with the processor 120. In another embodiment, the database 150 may be external to the processor 120.

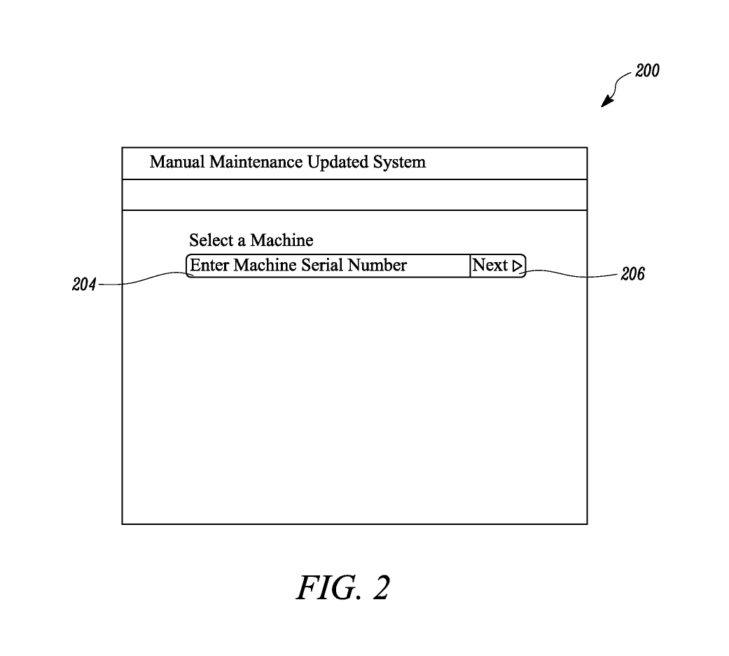

Further, the processor 120 receives one or more inputs from the maintenance schedule interface 200. Referring to FIGS. 2 to 4, the maintenance schedule interface 200 of the maintenance system 100 is illustrated. The maintenance schedule interface 200 may be at least one of a touch based interface, a keyboard based interface, a pointing device (e.g., a mouse) based interface, or a combination thereof. The maintenance schedule interface 200 allows the user to provide inputs for generating of the maintenance schedule. In an embodiment, the maintenance schedule interface 200 may be associated with a web-based application that is configured to provide maintenance schedule of the machine 102 associated with a particular manufacturing company. In various other embodiments, the maintenance schedule interface 200 may be associated with maintenance applications such as, but not limited to, a third party data provider, an ERP system and an SAS system. Moreover, the maintenance schedule interface 200 from the web based application may be accessed by using authentication information, for example, a username and a password. In another embodiment, the maintenance schedule interface 200 may be accessed through an onboard telematics system associated with the machine 102. In yet another embodiment, the maintenance schedule interface 200 may be accessed through a portable computing device, such as mobile, tablet, laptop, and the like.

The maintenance schedule interface 200 may include multiple graphical control elements that may allow the user to provide inputs related to various functions such as, but not limited to, a selection of one or more features, creation of one or more files, views and the like. The processor 120 may be configured to receive the inputs via one or more of these graphical control elements and accordingly perform tasks or execute the instructions. Further, the processor 120 may also be configured to provide, via the maintenance schedule interface 200, the output i.e., the maintenance schedule for display to the user.

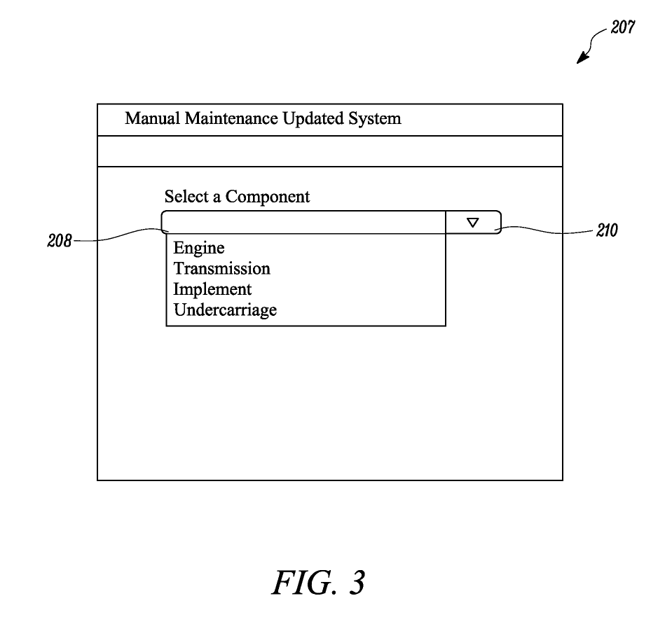

Referring to FIG. 2, the maintenance schedule interface 200 includes a control element 204 that allow the user to provide input corresponding to selection of a machine from a plurality of machines associated with the maintenance system 100. The control element 204 allows a user to provide an identification code, the identification code is indicative of unique information specific to the machine 102. In an embodiment, the identification code for the machine 102 may include information that may be, identifiers for the machine 102 such as, a serial number, SAP id, project name, project number; a description or a specification of the machine 102 such as, make, model, model year, type of machine; a location information such as, area name, area number, owning district, region, using district, current location; and the like. The maintenance schedule interface 200 also includes a next button 206. Upon clicking the next button 206, the processor 120 may store the identification code of the machine 102 and lookup in the database 150 to retrieve machine information. Subsequently, the processor 120 may also display or navigate to a first process tab 207 (shown in FIG. 3) of the maintenance schedule interface 200. The first process tab 207 may be, for example, a window, a dialogue box, a page, etc.

Referring to FIG. 3, the first process tab 207 includes a control element 208. The control element 208 allows a user to provide first input indicative of selection a component in the machine 102. In the illustrated embodiment, the control element 208 is a drop down box listing different components of the machine 102. In various alternate embodiments, the control element 208 may be an input box, list box and the like. The control element 208 allows the user to select a component from a list of the one or more components of the machine 102. The first process tab 207 also includes a navigation button 210. Further, upon clicking the navigation button 210, the processor 120 may receive instructions associated with the component from the database 150.

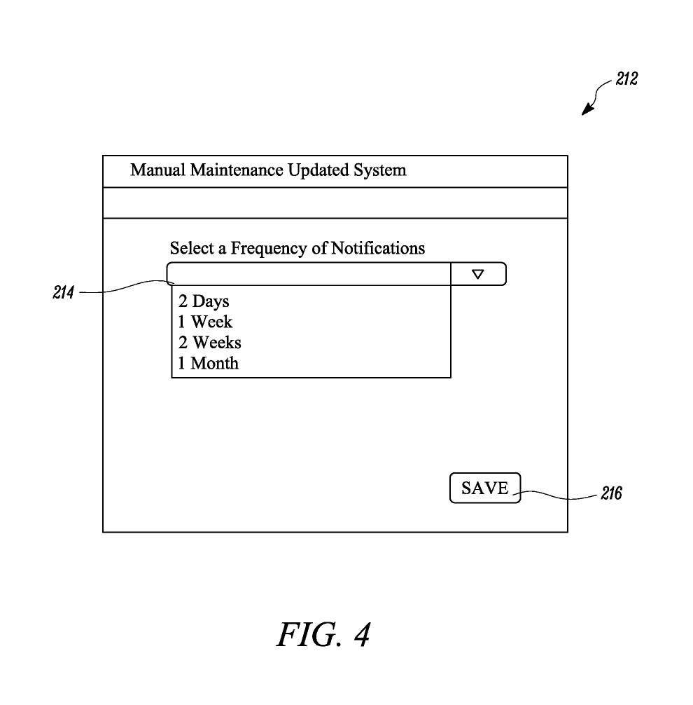

Referring to FIG. 4, the processor 120 displays a second process tab 212 as the user clicks the navigation button 210 of the first process tab 207. The second process tab 212 includes a control element 214 that allows the user to provide a second input corresponding to a selection of frequency of notifications. The control element 214 allows the user to set notification frequency for the component based on various parameters related to the machine 102. In an example, the notifications may be set based on a location, a status of the machine, application of the machine, or other parameters. The second process tab 212 also includes a control element 216 that allows the user to save the notification frequency. The frequency of notifications may be stored in the database 150 and the processor 120 may be configured to send the notification to the user at a time interval defined by the frequency of notifications. Particularly, the output module 126 of the processor 120 further receives the second input and accordingly sends the notification to the user based on the frequency of notifications.

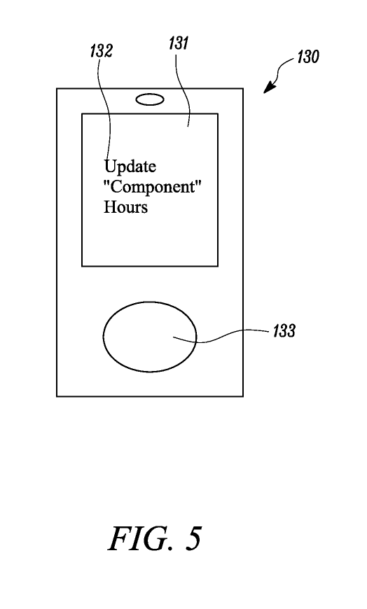

Referring to FIG. 5, the user device 130 is configured to receive the notifications, based on the notification frequency received via the control element 214 of the second process tab 212. The user device 130 is configured to receive a notification via at least one of a short message service (SMS), a multimedia message service (mms), a pull notification, and an electronic mail (e-mail). The user device 130 may also be configured to allow the user to provide one or more inputs associated with updating of the maintenance schedule. In an embodiment, the user device 130 may be a portable computing device that operates using a portable power source such as a battery. Examples of the portable computing device may include, but are not limited to, a mobile phone, a smart phone, a palm top, a tablet, a laptop and the like. The user device 130 may also have a display interface 131 which may or may not be a touch sensitive display. More specifically, the display interface 131 may have a capacitance sensor that may be used to provide input data to the user device 130. In an embodiment, an input pad 133 such as arrows, buttons, scroll wheels, keyboards, etc., may be used to provide inputs to the user device 130. In addition, the user device 130 may have a microphone (not shown) which may accept and store audible data. The user device 130 may receive user inputs from at least one of the input pad 133 and the microphone.

As shown in FIG. 5, the user may receive a communication message 132 through the user device 130. The communication message 132 may be indicative of a request for the user to update an operational parameter of the component. In an embodiment, the operation parameter may be number of operating hours of the component and/or the machine 102 before a scheduled maintenance.

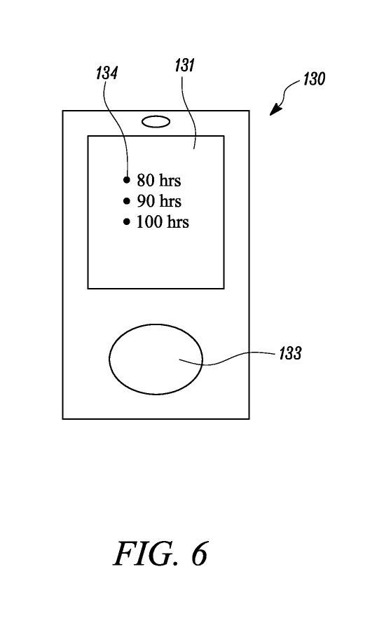

Referring to FIG. 6, upon receiving the communication message 132, the user may seek to update the component hours. For example, as shown in the FIG. 6, the user may provide user input values, the operational parameter, such as, 80 hours, 90 hours, and 100 hours. Based on the user inputs, the user device 130 may generate a communication response message 134. As may be understood, the communication response message 134 includes the inputs provided by the user. The user device 130 may subsequently transmit the communication response message 134 to the processor 120 via the network 110. The communication response message 134 may be at least one of a short message service (SMS), a multimedia message service (mms), a push notification, and an electronic mail (e-mail). Alternatively, the user may also provide the input by accessing the maintenance schedule interface 200. In such a case, the user may access the maintenance schedule interface 200 via a computer device such as a computer to provide the operational parameter to the processor 120.

The input module 122 of the processor 120 further receives a third input indicative of the operational parameter. The input module 122 may process the received third input and send the input signal to the processing module 124. The processing module 124 may further generate the maintenance schedule based on the set of data associated with the machine 102, and the operational parameter received from the user. In an embodiment, the processing module 124 may retrieve a performed maintenance schedule of the components from the database 150 and accordingly update the maintenance schedule based on the number of working hours of the components.

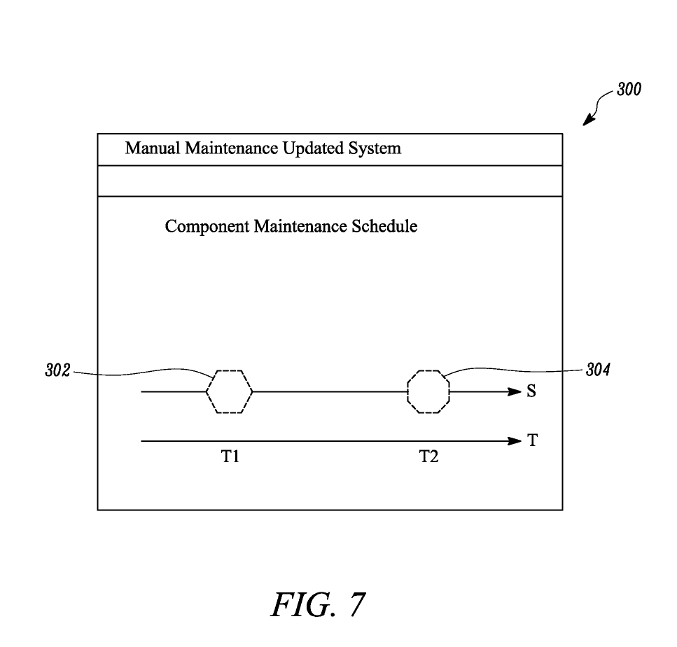

FIG. 7 is an exemplary output 300 of the processor 120. The processor 120 generates the output 300 based on the operational parameter and the set of data. In an embodiment, the output 300 is represented as a plot of maintenance operation of one or more components of the machine 102 against a timeline ‘T’ associated with the maintenance schedule.

In the illustrated embodiment, maintenance ‘S’ of a component of the machine 102 is represented by a plot of multiple indicators 302, 304 against the timeline ‘T’. As shown, the output 300 corresponds to a repair operation of the component of the machine 102 against the timeline ‘T’. Each of the indicators 302, 304 indicates a corresponding repair operation for the particular component of the machine 102. In an embodiment, the indicators 302, 304 may also represent a type of service operation to be performed on a corresponding date of the timeline. In an example, the indicator 302 indicates a cleaning operation of an air filter of the machine at a time instance ‘T1’. Similarly, the indicator 304 indicates a changing lubricating oil operation of a transmission assembly of the machine 102 at time instance ‘T2’.

A person of ordinary skill in the art will acknowledge that the maintenance schedule interface 200 and the corresponding graphical control elements explained above are merely exemplary in nature and hence non-limiting of this disclosure. Moreover, necessary design and/or functional modifications may be possible for the maintenance schedule interface 200 without deviating from the scope of the present disclosure.

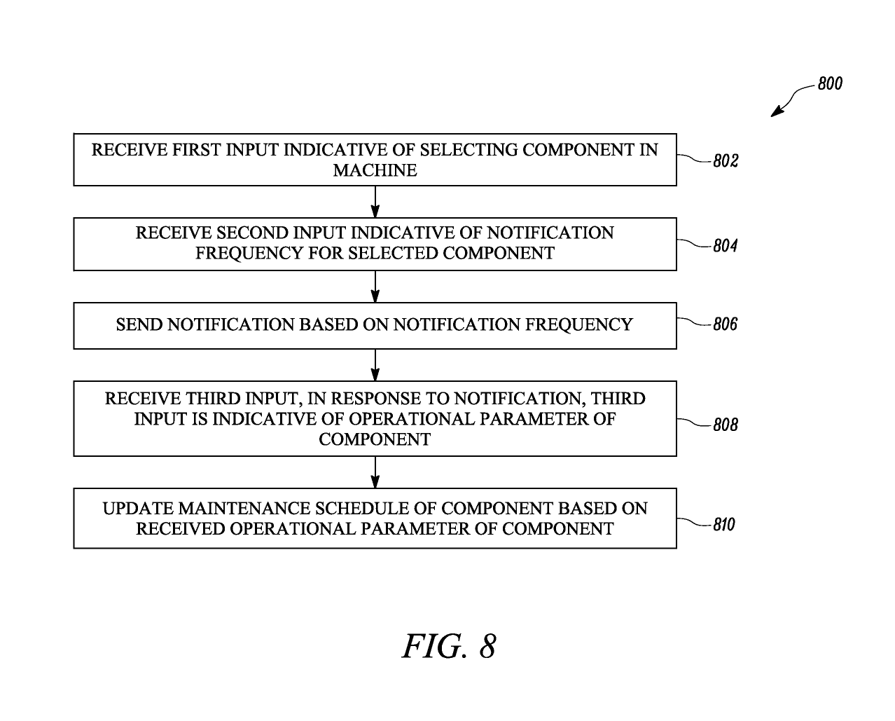

FIG. 8 illustrates a flow chart of a method 800 for updating a maintenance schedule for the machine 102. In an embodiment, the method 800 may be implemented via the maintenance system 100 described above. In an alternate embodiment, the method 800 may be implemented using a software, the software may be stored in a computer program product and loaded into a computer based system, which is when executed by a processor associated with the computer based system, causes the processor to the functions of the present disclosure as described herein.

At step 802, the method 800 includes receiving the first input indicative of selecting a component in the machine 102. As described above, the processor 120 of the maintenance system 100 may receive the first input via, the maintenance schedule interface 200. The maintenance schedule interface 200 includes the control element 208 that allows the user to select the component of the machine 102. Based on the first input, the processor 120 may further retrieve instructions associated with the component from the database 150.

At step 804, the method 800 includes receiving the second input indicative of a notification frequency for the selected component. The processor 120 may receive the second input via the second process tab 212 of the maintenance schedule interface 200. The second process tab 212 includes the control element 214 that allows the user to provide input corresponding to the notification frequency for the selected component. More particularly, the input module 122 of the processor 120 receives the second input via the maintenance schedule interface 200.

At step 806, the method 800 includes sending the notification based on the notification frequency. As described above, the output module 126 of the processor 120 is configured to receive instructions related to the notification frequency and send the notification based on the notification frequency. The output module 126 is configured to send a notification to the user via at least one of a short message service (SMS), a multimedia message service (MMS), a push notification, and an electronic mail (E-mail).

At step 808, the method 800 includes receiving the third input, in response to the notification. The third input is indicative of an operational parameter of the component. In an embodiment, the processor 120 may receive the third input from the user device 130 in response to the notification. In various alternative embodiments, the user may also update the number of operational hours from the maintenance schedule interface 200. The input module 122 of the processing receives a third input indicative of the operational parameter. The input module 122 may format the received third input and send a formatted module input to the processing module 124.

At step 810, the method 800 includes updating the maintenance schedule of the component based on the received operational parameter of the component. The processing module 124 may update the maintenance schedule based on the set of data received from the database 150, and the operational parameter received from the user. In an embodiment, the processing module 124 may retrieve a performed maintenance schedule of the component from the database 150 and accordingly update the maintenance schedule based on the number of working hours of the component for a time interval corresponding to the notification frequency.

In an embodiment, the method 800 may also includes displaying the updated maintenance schedule of the machine 102 to the user. The processor 120 is configured to generate the output 300 (shown in FIG. 7) based on the operational parameter and the set of data. In an embodiment, the output 300 is represented as a plot of maintenance of one or more components of the machine 102 against a timeline associated with the maintenance schedule. In the illustrated embodiment, the output 300 corresponds to a plot of a repair operation of a component of the machine 102 against the timeline.

Various embodiments disclosed herein are to be taken in the illustrative and explanatory sense, and should in no way be construed as limiting of the present disclosure. All numerical terms, such as, but not limited to, “first” and “second” or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

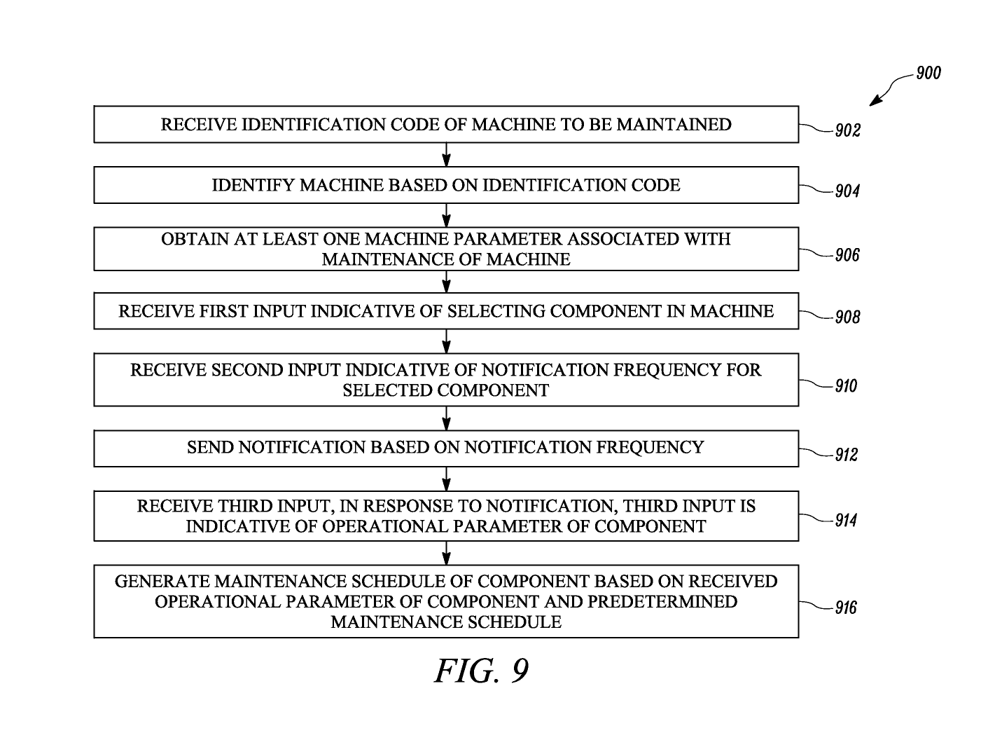

FIG. 9 illustrates a flowchart of a method 900 for generating the maintenance schedule for the machine 102, according to an embodiment of the preset disclosure. In an embodiment, one or more steps of the method 900 may be implemented using the maintenance schedule interface 200 described above.

At step 902, the method 900 includes receiving an identification code of the machine 102 to be maintained. The identification code is indicative of unique information specific to the machine 102. The processor 120 receives the identification code via the control element 204 of the maintenance schedule interface 200. In an embodiment, the identification code for the machine 102 may include information that may be, identifiers for the machine 102 such as, a serial number, a SAP id, a project name, a project number; a description or a specification of the machine 102 such as, make, model, model year, type of machine 102; a location information such as, area name, area number, owning district, region, using district, current location, and the like.

At step 904, the method 900 includes identifying the machine 102 based on the identification code. The processing module 124 of the processor 120 may run a program/algorithm to analyze the identification code of the machine 102 based on the machine information stored in the database 150. At step 906, the method 900 includes obtaining at least one machine parameter associated with the maintenance of the machine 102. The processor 120 may be configured to lookup in the database 150 to obtain machine parameter based on the identification code from the user. In an embodiment, the machine parameter may correspond to a utility of machine, a machine specification, a type of machine, an engine serial number and a running life cycle of one or more components of the machine 102.

At step 908, the method 900 includes receiving the first input indicative of selecting a component in the machine 102. As described above, the processor 120 of the maintenance system 100 may receive the first input via, the maintenance schedule interface 200. The maintenance schedule interface 200 includes the control element 208 that allows the user to select the component of the machine 102. Based on the first input, the processing module 124 may retrieve the set of data associated with the component of the machine 102 from the database 150.

At step 910, the method 900 includes receiving the second input indicative of a notification frequency for the selected component. The processor 120 may receive the second input via the second process tab 212 of the maintenance schedule interface 200. The second process tab 212 includes the control element 214 that allows the user to provide input corresponding to the notification frequency for the selected component. More particularly, the input module 122 of the processor 120 receives the second input via the maintenance schedule interface 200.

At step 912, the method 900 includes sending the notification based on the notification frequency. As described above, the output module 126 of the processor 120 is configured to receive instructions related to the notification frequency and send the notification based on the notification frequency. In an embodiment, the output module 126 is configured to send a notification to the user via at least one of a short message service (SMS), a multimedia message service (MMS), a push notification, and an electronic mail (E-mail).

At step 914, the method 900 includes receiving the third input, in response to the notification. The third input is indicative of an operational parameter of the component. In an embodiment, the processor 120 may receive the third input from the user device 130 in response to the notification. In various alternative embodiments, the user may also update the number of operational hours from the maintenance schedule interface 200. The input module 122 of the processing receives a third input indicative of the operational parameter. The input module 122 may format the received third input and send the input signal to the processing module 124.

At step 916, the method 900 includes generating the maintenance schedule of the component based on the received operational parameter of the component. The processing module 124 may generate the maintenance schedule based on the set of data received from the database 150, and the operational parameter received from the user. In an embodiment, the processing module 124 may retrieve a machine parameter from the database 150 and accordingly generate the maintenance schedule for each of the components of the machine 102 based on the first input, the second input, and the third input for each component of the machine 102. The processing module 124 may also be configured to periodically update the maintenance schedule based on the number of working hours of the component for a time interval corresponding to the notification frequency

In an embodiment, the method 900 may also include displaying the generated maintenance schedule of the machine 102 to the user. The processor 120 is configured to generate the output 300 (shown in FIG. 7) based on the operational parameter and the machine parameter. In an embodiment, the output 300 is represented as a plot of maintenance ‘S’ of one or more components of the machine 102 against a timeline ‘T’ associated with the maintenance schedule.

The maintenance system 100 and the method 900 of the present disclosure have applicability for use and implementation in generating the maintenance schedule for a number of machines. Moreover, the maintenance system 100 may be implemented as a web-application to enable the users to view the telematics data via the maintenance schedule interface 200. Additionally, with use of the maintenance system 100 and the method 900, the output may be updated periodically based on the third input received from the user. Therefore, a real time maintenance management of the machine 102 may be obtained.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of updating a maintenance schedule for a machine, the method comprising:
receiving a first input indicative of selecting a component in the machine;
receiving a second input indicative of a notification frequency for the selected component;
sending a notification based on the notification frequency;
receiving a third input, in response to the notification, the third input is indicative of an operational parameter of the component; and
updating the maintenance schedule of the component based on the received operational parameter of the component.

2. The method of claim 1, further comprising displaying the updated maintenance schedule of the machine to a user.

3. The method of claim 1, wherein the operational parameter of the component is a number of operating hours of the component.

4. The method of claim 1, wherein the notification is sent to a user via at least one of a Short Message Service (SMS), a Multimedia Message Service (MMS), a push notification, and an Electronic mail (E-mail).

5. A maintenance system for a machine comprising:
a maintenance schedule interface configured to receive a first input and a second input, the first input is indicative of selecting a component in the machine and the second input is indicative of a notification frequency for the selected component; and
a processor in communication with the maintenance schedule interface, the processor comprising:
an output module configured to send a notification, based on the notification frequency, to a user device;
an input module configured to receive a third input indicative of an operational parameter of the component; and
a processing module configured to update the maintenance schedule of the component based on the received operational parameter of the component.

6. The maintenance system of claim 5, further comprising a database, in communication with the processor, configured to store a set of data associated with machine, wherein the set of data comprises at least one of predefined maintenance schedule, machine information, and user information.

7. The maintenance system of claim 5, wherein the maintenance schedule interface is configured to display the updated maintenance schedule of the machine to a user.

8. The maintenance system of claim 5, wherein the operational parameter of the component is a number of operating hours of the component.

9. The maintenance system of claim 5, wherein the output module is configured to send a notification to a user via at least one of a Short Message Service (SMS), a Multimedia Message Service (MMS), a push notification, and an Electronic mail (E-mail).

10. A method for generating a maintenance schedule for a machine, the method comprising:
receiving an identification code of the machine to be maintained, the identification code being indicative of unique information specific to the machine;
identifying the machine based on the identification code;
obtaining at least one machine parameter associated with the maintenance of the machine;
receiving a first input indicative of selecting a component in the machine;
receiving a second input indicative of a notification frequency for the selected component;
sending a notification based on the notification frequency;
receiving a third input, in response to the notification, the third input is indicative of an operational parameter of the component; and
generating the maintenance schedule of the component based on the received operational parameter of the component and the predetermined maintenance schedule.

11. The method of claim 10, further comprising updating the maintenance schedule based on the third input.

12. The method of claim 10, further comprising displaying the generated maintenance schedule of the machine to a user.

13. The method of claim 10, wherein the operational parameter of the component is a number of operating hours of the component.

14. The method of claim 10, wherein the notification is sent to a user via at least one of a Short Message Service (SMS), a Multimedia Message Service (MMS), a push notification, and an Electronic mail (E-mail).
